(19) United States
(12) Patent Application Publication
(10) Pub. No.: US 2002/0101151 A1
(43) Pub. Date: Aug. 1, 2002

(54) Plasma switched organic photoluminescent display

(76) Inventors: Do-Hyun Choi, Seoul (KR); Kyung-Hee Choi, Seoul (KR); Byung-Hyun Byun, Daejeon (KR); Seung-Jun Yi, Seoul (KR)

Correspondence Address: BIRCH STEWART KOLASCH & BIRCH, PO BOX 747, FALLS CHURCH, VA, 22040-0747, US

(21) Appl. No.: 10/002,178

(22) Filed: Dec. 5, 2001

(30) Foreign Application Priority Data
Dec. 5, 2000 (KR) 2000-73326
Apr. 26, 2001 (KR) 2001-22612
Sep. 15, 2001 (KR) 2001-57048
Nov. 8, 2001 (KR) 2001-69613

(51) Int. Cl. H01J 61/00

(52) U.S. Cl. 313/484; 313/485; 313/487; 313/489; 313/491; 428/690

(57) ABSTRACT

Described is a plasma switched organic photoluminescent display including lower and upper plates. The lower plate includes a transparent rear substrate, a plurality of address electrodes arranged in a first direction on the transparent rear substrate like stripes in parallel each other, a white back dielectric layer on the transparent rear substrate including the address electrodes, a plurality of barrier ribs arranged in parallel each other on the white back dielectric layer between the address electrodes in the first direction, respectively, a plurality of organic photoluminescent layers on the exposed white back dielectric layer between the barrier ribs, respectively, and a plurality of photoluminescent-layer-protecting layers on the organic photoluminescent layers, respectively. The upper plate includes a transparent front substrate, a plurality of transparent sustain electrodes arranged in parallel each other like stripes on the transparent front substrate in a second direction, a plurality of auxiliary sustain electrodes on the sustain electrodes, respectively, so as to reduce resistances of the sustain electrodes, a transparent dielectric layer on the front substrate so as to cover the sustain and auxiliary sustain electrodes, and a protecting layer on the transparent dielectric layer.

### BACKGROUND OF THE INVENTION

1. Field of the Invention

The present invention relates to an organic photoluminescent display, and more particularly, to a plasma switched organic photoluminescent display making the organic luminescent material emit light by ultraviolet rays which are emitted from a plasma, thereby enabling to prevent a degradation of an organic luminescent material due to a current as well as improve a brightness of the display.

2. Background of the Related Art

As information telecommunication technologies have been greatly developed, a variety of demands for electronic display devices are highly increased to keep up with the developing information society. And, so does the demands for various displays. In order to satisfy the demands of the information society, for electronic display devices are required characteristics such as high-resolution, large-size, low-cost, high-performance, slim-dimension, and small-size and the like, for which new flat panel displays (FPD) are developed as substitutions for the conventional cathode ray tube (CRT).

One of the FPDs is an electroluminescent display (hereinafter abbreviated ELD). ELD is divided into two categories, i.e. organic electroluminescent display (hereinafter abbreviated OELD) and inorganic electroluminescent display (hereinafter abbreviated IELD) in accordance with materials used for field luminescent layers respectively.

IELD, which emits light using the collisions of electrons accelerated by an high electric filed, is classified into AC thin film ELD, AC thick film ELD, DC thin film ELD, and the like in accordance with thickness of the thin films and driving systems.

And, OELD, which emits light by a current flow, is classified into low-molecular OELD and high-molecular OELD.

FIG. 1 illustrates a cross-sectional view of a schematic construction of OELD.

Referring to FIG. 1, stacked in order are a transparent anode layer 12 formed on a transparent substrate 11, a hole injection layer 13, a hole transport layer 14, an organic luminescent layer 15, an electron transport layer 16, and a cathode layer 18 formed of metal. And, the organic luminescent layer 15 emits light by a flow of a current. The hole injection layer 13, hole transport layer 14, and electron transport layer 16 play an auxiliary role in increasing a luminescent efficiency of OELD.

In accordance with the luminescent materials for OELD, the organic luminescent layer 15 is formed one of a fluorescent emitting material such as aluminum tris (8-hydroxyquinoline), i.e. Alq3, perylene and the like, which are disclosed on U.S. Pat. Nos. 4,769,292 and 5,294,870 so as to construct a fluorescent display, and phosphorescent emitting materials such as platinum 2,3,7,8,12,12,17,18-octaethyl-21H,23H-porphine, i.e. PtOEP, iridium complex of Ir (PPY) 3 and the like and a blocking layer of bathocuproine, i.e. BCP, cabazole biphenyl, i.e. CBP, N,N′-diphenyl-N,N′-bis-alpha-napthylbenzidine, i.e. NPD, inserted between the hole and electron transport layers 14 and 14 disclosed on U.S. Pat. No. 6,097,147 so as to construct phosphorescent OELD. Particularly, high-molecular OELD has a stacked structure of the hole transport and electroluminescent layers 14 and 15 between the transparent anode and cathode layers 12 and 18. A material for the high-molecular OELD is a conductive high molecule as a kind of conjugated polymers disclosed on U.S. Pat. Nos. 5,399,502, and 5,807,627 such as poly (p-phenylenevinylene), i.e. PPV, poly (thiophene), poly (2,5-dialkoxyphenylene-vinylene, i.e. PDMeOPV or the like.

The species of organic electroluminescent materials of the organic luminescent materials and their luminescent wavelengths are shown in Table 1.

Table 1

| Organic electro- or photo-luminescent | Wavelength of |
|---|---|
| material | discharged light |
| 4-bis (2,2′ -diphenylethene-4-yl) -diphenyl | 465 nm |
| tris (8-hydroxyquinoline) aluminum | 520 nm |
| bis (8-hydroxyquinoline) magnesium | 515 nm |
| Coumarine 6 | 503 nm |
| Rubrene | 560 nm |
| poly (p-phenylenevinylene), PPV | 540 nm |

Such OELD is divided into active and passive types in accordance with the driving systems. The passive type OELD follows a current driving system so that an efficiency of power consumption and a device reliability are decreased as a panel size increases. To settle such problems in case that a diagonal diameter of a panel is longer than 10 inches, the active type OELD using polysilicon thin film transistors (poly-Si TFT) as driving devices is widely used.

Yet, when the polysilicon TFT is used as the driving device, the current technology fails to secure a uniformity of a thin film to drive OELD. And, the current technology also requires at least two TFTs for driving the OELD, thereby failing to secure a device reliability and a sufficient yield as well as realize a large-sized screen. And, the current technology also needs a complicated fabricating process, a high-vacuum process requiring an ultra vacuum environment and an expensive equipment for fine photolithography, and a high cleanness less than class 100, whereby a high cost of production is inevitable.

Meanwhile, at the stage of commercial use is a plasma display panel (hereinafter abbreviated PDP) using a memory function of plasma by wall charges formed on a dielectric layer on a sustain electrode. Specifically, compared to OELD or poly-Si TFT display, PDP is suitable for a wide screen exceeding a size over 42 inches. PDP is divided into a DC type driven by DC (direct current) and an AC type driven by AC (alternating current). A PDP manufacturer produces the AC type PDP showing better results in a driving voltage and a horizontal plane than the DC type.

FIG. 2 illustrates a schematic bird's-eye view of PDP according to a related art. FIG. 2 shows an example of a general 3-electrodes surface discharge AC type PDP disclosed on each of U.S. Pat. Nos. 5,420,602, 5,661,500, and 5,674,553, of which pixel area is shown as follows.

Referring to FIG. 2, the pixel area is provided by a front glass 20 like a transparent plate such as a glass on an image display surface and a rear glass 21 placed in parallel with the front glass 21.

On the front glass 20 formed are a plurality of transparent sustain electrodes 26 constructing pairs of electrodes X and Y on a surface confronting the rear glass 21 with uniform intervals and a plurality of auxiliary sustain electrodes 27 constructed on the sustain electrodes 26 respectively with metal layers having widths narrower than those of the sustain electrodes 26 so as to reduce resistances of the sustain electrodes 26 respectively.

And, black stripes 28 are formed between the pairs of the sustain electrodes 26 on the front glass 20 in parallel with the sustain electrodes 26 so as to increase a contrast ratio. A dielectric layer 29 controlling a discharge current is formed on a display area including the sustain electrodes 26, auxiliary sustain electrodes 27, and black stripes 28. And, a protecting layer 30 is formed, using of a material such as MgO or the like having a high secondary electron discharge coefficient to help to generate plasma with ease, on the dielectric layer 29 so as to protect the dielectric layer 29 from plasma etch.

Meanwhile, the rear glass 21 includes a plurality of stripe type barrier ribs 22 defining a plurality of discharge spaces so as to cross the sustain electrodes 26 at right angles respectively, a plurality of address electrodes 23 between the barrier ribs 22 so as to cross the sustain electrodes 26 at right angles respectively, a white back dielectric layer 24 covering the entire pixel area including the address electrodes 23 so as to protect the address electrodes 23 as well as reflect lights emitted from a fluorescent (phosphor) layer 25, and a fluorescent layer 25 on the white back dielectric layer 24 and both inner walls of the respective barrier ribs 22 inside the respective discharge spaces so as to radiate visible rays on plasma discharge.

Specifically, in order to increase the contrast ratio when the barrier ribs 22 are formed, lower barrier ribs 22a are firstly formed and then upper barrier ribs 22b are formed on the lower barrier ribs 22a.

FIG. 3 schematically illustrates cross-sectional views of the front and rear glasses of PDP shown in FIG. 2 along bisecting lines A-A′ and B-B′, respectively, in which the cross-sectional views of the front and rear glasses are combined each other in case that the front glass is rotated clockwise at 90° for the convenience of understanding.

Hg or one of noble gases such as He, Ne, Ar, Xe, Kr, Rn, and the like is used for plasma discharge, and various wavelengths of ultraviolet rays generated from the plasma discharge are shown in Table 2.

Table 2

| Plasma discharge gas | Generated wavelength |
|---|---|
| High pressure Hg | 297 nm, 313 nm, 365 nm |
| Low pressure Hg | 135 nm, 254 nm |
| Kr | <400 nm |
| He—Xe | |
| He—Ne—Xe | 147 nm, 173 nm |
| He—Xe | |

Explained in the following is an image display process of a random cell in the above-constructed surface discharge AC type PDP (hereinafter abbreviated AC-PDP) according to a related art.

The image display process mainly includes a total white and erase period carrying out a whole surface discharge and a whole surface erase, an address period bringing about a discharge selectively in accordance with display data, and a sustain period carrying out a sustain discharge on a lighted cell during the address period.

The total white and erase period includes an erase step of discharging a whole surface of the pixel area and removing generated wall charges so as to initialize the whole surface of PDP uniformly and constantly.

In order to discharge the whole surface of the pixel area, an initializing voltage of 150V˜300V is applied between the X and Y electrodes constructing the pair of the sustain electrodes (line)

In the discharge space where a ‘discharge’ is generated, wall charges and charged particles exist. The total white and erase period is completed by applying an erase voltage enough not to generate the discharge to the X and Y electrodes so as to remove the wall charges and charged particles. The erase voltage, using the same potential of the initializing voltage, may be applied thereto for a short period of time so as not to generate the discharge.

The address period is carried out by applying a positive address pulse to the address electrode in order and by applying a negative scan pulse synchronized with the address pulse to the Y electrode in accordance with the display data selectively.

The scan pulse is applied to the pixel area having the display data only but fails to be applied to the pixel area having no display data. As a result, the discharge is generated from the cell to which the address and scan pulses are applied simultaneously. Hence, wall charges are accumulated in the lighted cell.

And, the sustain period generates a plurality of the number of times of ‘sustain discharges’ from the cell where the wall charges are accumulated by applying sustain discharge pulses to the X and Y electrodes alternately. In this case, a brightness of the corresponding cell is controlled by the number of times (frequency).

The sustain discharge pulse should include a discharge voltage and a discharge period so that the discharge occurs in the cell selected during the address period, and vice versa.

In case of AC-PDP, a fabricating process is carried out at a high temperature over 400° C. and most of the patterns are formed by a screen print method or the like. Therefore, the fabricating process is simple. Cost of equipments for AC-PDP is cheaper than that of photolithography equipments. AC-PDP is suitable for a wide display over 40 inches. And, AC-PDP uses a photoluminescent mechanism.

However, an inorganic fluorescent (i.e. phosphor) material used as a light-emitting material is printed between the barrier ribs as a paste form and then an organic polymer binder is burnt at a high temperature. In this case, degradation of the inorganic fluorescent material proceeds due to the high temperature. And, the resulted inorganic fluorescent layer becomes very porous so as to be broken easily by a little stimulation. Hence, the resulted inorganic fluorescent layer is degraded, thereby reducing an yield of a panel production critically.

Moreover, the inorganic fluorescent material has a decay time amounting to several ˜tens ms, thereby showing a residual image when presenting moving pictures. And, a color purity of the inorganic fluorescent material is so low that improvement of the material is essential to manufacture a high definition panel.

Furthermore, the paste used for manufacturing PDP includes an organic polymer binder and an organic solvent, which are randomly mixed with an inorganic material such as a glass for the printing process such as screen-printing, thereby increasing the danger of phase separation. Therefore, the paste deteriorates with ease so as to waste a material for manufacturing PDP as well as increase a cost of production.

### SUMMARY OF THE INVENTION

Accordingly, the present invention is directed to a plasma switched organic photoluminescent display that substantially obviates one or more of the problems due to limitations and disadvantages of the related art.

An object of the present invention is to provide a plasma switched organic photoluminescent display (PSOPLD) enabling to have a simple structure by taking an active driving system using a memory function of plasma and ultraviolet rays generated from a plasma discharge for photoluminescence, extend its durability without degradation due to an electric current, and improve its brightness.

In order to overcome the disadvantages of expensive equipments, a high cost of production, a poor yield, and the degradation of a luminescent layer due to a current driving system for manufacturing the previous polysilicon TFT OELD, another object of the present invention is to provide a plasma switched organic photoluminescent display enabling to improve a durability of a device by realizing colors through a photoluminescent mechanism, simplify a manufacturing process to reduce a cost of production by removing auxiliary layers such as hole injection, hole transport, electron transport layers, and the like, and increase a commercial productivity by improving a surface adhesiveness of a layer using an organic luminescent material instead of an organic fluorescent (phosphor) material reducing critically the yield of production in the previous AC-PDP. Specifically, a phosphor material having an efficiency three times more excellent than that of a fluorescent material is preferably used, thereby enabling to improve the disadvantage caused by the poor efficiency of the inorganic fluorescent material.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages, and in accordance with the purpose of the present invention as embodied and broadly described, a plasma switched organic photoluminescence display according to the present invention includes a plasma generating means for generating a plasma and an organic photoluminescent layer irradiating visible rays by being excited by UV rays generated from the plasma generating means wherein the organic photoluminescent layer is formed of an organic photoluminescent material.

Preferably, the organic photoluminescent layer includes a red luminescent layer, a green luminescent layer, and a blue luminescent layer.

In another aspect of the present invention, a plasma switched organic photoluminescence display includes upper and lower plates. The lower plate includes a transparent rear substrate, a plurality of address electrodes arranged in a first direction on the transparent rear substrate like stripes in parallel each other, a white back dielectric layer on the transparent rear substrate including the address electrodes, a plurality of barrier ribs arranged in parallel each other on the white back dielectric layer between the address electrodes in the first direction, respectively, a plurality of organic photoluminescent layers on the exposed white back dielectric layer between the barrier ribs, respectively, and a plurality of photoluminescent-layer-protecting layers on the organic photoluminescent layers, respectively. And, the upper plate includes a transparent front substrate, a plurality of transparent sustain electrodes arranged in parallel each other like stripes on the transparent front substrate in a second direction, a plurality of auxiliary sustain electrodes on the sustain electrodes, respectively, so as to reduce resistances of the sustain electrodes, a transparent dielectric layer on the front substrate so as to cover the sustain and auxiliary sustain electrodes, and a protecting layer on the transparent dielectric layer.

Preferably, the upper and lower plates are aligned to each other so that the address electrodes cross sustain electrode pairs at right angle, each of the sustain electrode pairs is constructed with a pair of the sustain electrodes adjacent to each other, and plasmas are generated from spaces between the barrier ribs, respectively.

Preferably, the protecting layer is formed of MgO and the photoluminescent-layer-protecting layers are formed one of MgF₂, SiO₂, and CaF₂.

Preferably, the plasma switched organic photoluminescent display further includes a plurality of black stripes between the sustain electrode pairs in the second direction, respectively.

Preferably, the black stripes are formed on the front substrate, and the organic photoluminescent layers include red, green, and blue luminescent layers.

Preferably, the organic photoluminescent layers are formed one of the fluorescent, phosphorescent, and polymer luminescent materials disclosed on U.S. Pat. Nos. 4,769,292, 5,294,870, 6,097,147, 5,399.502, and 5,807,627.

In a further aspect of the present invention, a plasma switched organic photoluminescence display includes lower and upper plates. The lower plate includes a transparent rear substrate, a plurality of sustain electrodes arranged in parallel each other like stripes on the rear substrate in a first direction wherein every two of the adjacent sustain electrodes construct a sustain electrode pair, a white back dielectric layer on the rear substrate including the sustain electrodes, a plurality of barrier ribs arranged in parallel each other on the white back dielectric layer in a second direction perpendicular to the first direction so as to cross the sustain electrodes at right angle, respectively, and a plurality of protecting layers covering the white back dielectric layer exposed between the barrier ribs, respectively. The upper plate includes a transparent front substrate, a plurality of address electrodes arranged in a predetermined direction on the front substrate like stripes in parallel each other, a transparent dielectric layer formed on the front substrate so as to cover the address electrodes, a plurality of organic photoluminescent layers arranged on predetermined portions of the transparent dielectric layer so as to be overlapped with a plurality of pixel areas, wherein the pixel areas are defined by spaces between the barrier ribs overlapped with the sustain electrode pairs respectively when the upper and lower plates are aligned, and wherein each of the organic photoluminescent layers has a predetermined shape so as to cover the corresponding pixel area at least in part, and a photoluminescent-layer-protecting layer on the transparent dielectric layer so as to cover the organic photoluminescent layers. In this case, the upper and lower plates are aligned to each other in a manner that each of the address electrodes is placed between the barrier ribs and that each of the organic photoluminescent layers confronts the corresponding sustain electrode pair, and a plasma is generated form each space provided between the barrier ribs.

Preferably, the photoluminescent-layer-protecting layer is formed one of MgF₂, SiO₂, and CaF₂, and the protecting layers are formed of MgO.

Preferably, the upper plate further includes a plurality of black stripes over the front substrate so as to be overlapped with the spaces between the sustain electrode pairs, respectively.

More preferably, the black stripes are covered with the transparent dielectric layer.

Preferably, the organic photoluminescent layers centering around the corresponding address electrodes are symmetrically overlapped with the address electrodes, respectively.

Preferably, each of the address electrodes is placed over one side of the corresponding barrier rib when the upper and lower plates are aligned to each other, and the organic photoluminescent layers are formed in the pixel areas respectively so as not to be overlapped with the address electrodes.

Preferably, each of the address electrodes is placed over a middle part between the barrier ribs when the upper and lower plates are aligned to each other, and each of the organic photoluminescent layers is divided into a pair of equal parts in the pixel areas respectively so as not to be overlapped with the corresponding address electrode.

Preferably, the organic photoluminescent layers include red, green, and blue luminescent layers.

Preferably, the organic photoluminescent layers are formed one of the fluorescent, phosphorescent, and polymer luminescent materials disclosed on U.S. Pat. Nos. 4,769,292, 5,294,870, 6,097,147, 5,399.502, and 5,807,627.

In further another aspect of the present invention, a plasma switched organic photoluminescent display includes upper and lower plates. The lower plate includes a transparent rear substrate, a plurality of sustain electrodes arranged in parallel each other like stripes on the rear substrate in a first direction wherein every two of the adjacent sustain electrodes construct a sustain electrode pair, a white back dielectric layer on the rear substrate including the sustain electrodes, a plurality of barrier ribs arranged in parallel each other on the white back dielectric layer in a second direction perpendicular to the first direction so as to cross the sustain electrodes at right angle, respectively, and a plurality of protecting layers covering the white back dielectric layer exposed between the barrier ribs, respectively. And, the upper plate includes a transparent front substrate, a plurality of address electrodes arranged in a predetermined direction on the front substrate like stripes in parallel each other, a plurality of organic photoluminescent layers arranged on predetermined portions of the transparent dielectric layer so as to be overlapped with a plurality of pixel areas, wherein the pixel areas are defined by spaces between the barrier ribs overlapped with the sustain electrode pairs respectively when the upper and lower plates are aligned, and wherein each of the organic photoluminescent layers adjacent to the corresponding address electrodes has a predetermined shape so as to cover the corresponding pixel area at least in part, and a photoluminescent-layer-protecting layer on the front substrate so as to cover the address electrodes and organic photoluminescent layers. In this case, the upper and lower plates are aligned to each other in a manner that each of the address electrodes is placed between the barrier ribs and that each of the organic photoluminescent layers confronts the corresponding sustain electrode pair, and a plasma is generated form each space provided between the barrier ribs.

Preferably, the photoluminescent-layer-protecting layer is formed one of MgF₂, SiO₂, and CaF₂, and the protecting layers are formed of MgO.

Preferably, the upper plate further includes a plurality of black stripes over the front substrate so as to be overlapped with the spaces between the sustain electrode pairs, respectively.

Preferably, the organic photoluminescent layers include red, green, and blue luminescent layers.

Preferably, the organic photoluminescent layers are formed one of the fluorescent, phosphorescent, and polymer luminescent materials disclosed on U.S. Pat. Nos. 4,769,292, 5,294,870, 6,097,147, 5,399.502, and 5,807,627.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates a cross-sectional view of a schematic construction of OELD according to a related art;

FIG. 2 illustrates a schematic bird's-eye view of PDP according to a related art;

FIG. 3 illustrates schematically cross-sectional views of the front and rear glasses of PDP shown in FIG. 2 along bisecting lines A-A′ and B-B′, respectively;

FIG. 4 illustrates a schematic diagram of a plasma switched organic photoluminescent display according to the present invention;

FIG. 5 illustrates a schematic bird's-eye view of PSOPLD according to a first embodiment of the present invention;

FIG. 6 illustrates schematically cross-sectional views of upper and lower plates of PSOPLD shown in FIG. 5 along bisecting lines A-A′ and B-B′, respectively;

FIG. 7 illustrates a schematic bird's-eye view of PSOPLD according to a first embodiment of the present invention;

FIG. 8 illustrates schematically cross-sectional views of upper and lower plates of PSOPLD shown in FIG. 7 along bisecting lines A-A′ and B-B′, respectively;

FIG. 9 illustrates a schematic bird's-eye view of PSOPLD according to a third embodiment of the present invention;

FIG. 10 illustrates a layout of the lower plate of the PSOPLD according to the third embodiment of the present invention in FIG. 9;

FIG. 11A to FIG. 11C illustrate layouts of the upper plates of PSOPLD according to the third embodiment of the present invention;

FIG. 12 illustrates a schematic bird's-eye view of PSOPLD according to a fourth embodiment of the present invention;

FIG. 13 illustrates a schematic bird's-eye view of PSOPLD according to a fifth embodiment of the present invention; and

FIG. 14 illustrates a schematic bird's-eye view of PSOPLD according to a sixth embodiment of the present invention.

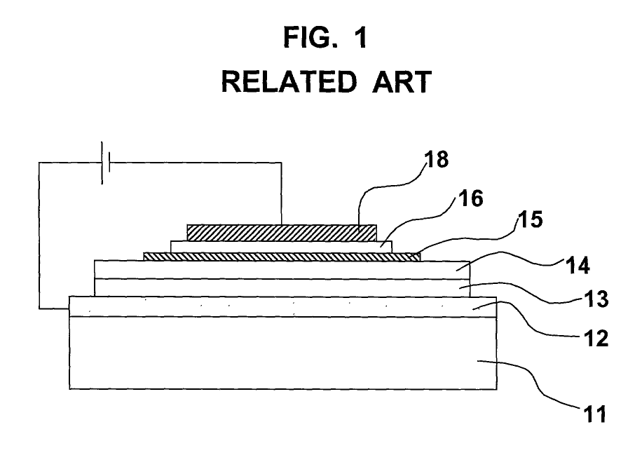

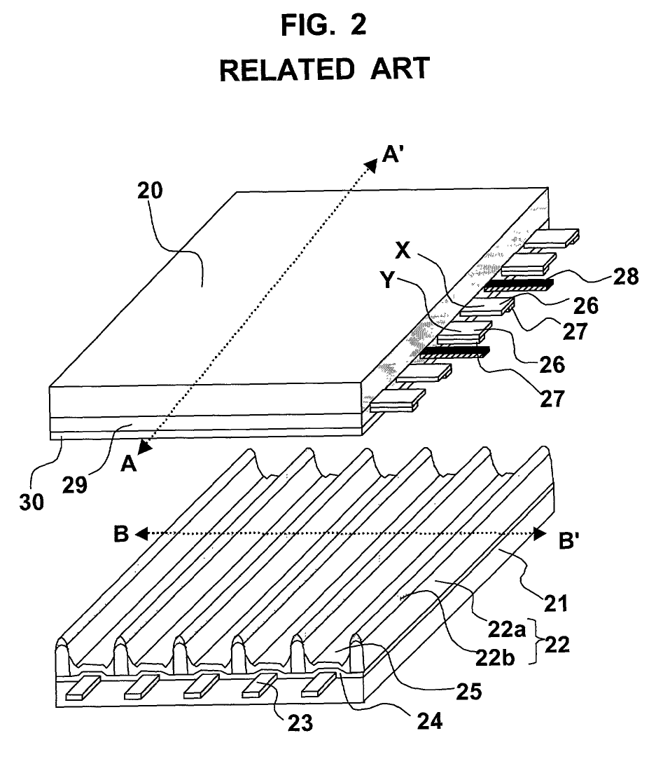

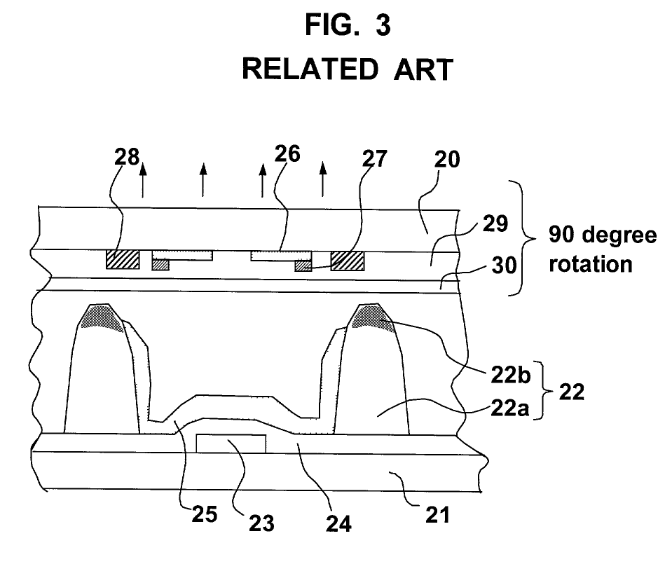

### DETAILED DESCRIPTION OF THE PREFERRED EMBODIMENTS

A plasma switched organic photoluminescent display according to the present invention uses the plasma discharge and memory function like the 3-electrodes surface discharge type AC PDP, and is driven by the driving system mentioned in the related art.

And, detailed component materials and techniques of the embodiments of the present invention include all those used for the related art.

Reference will now be made in detail to the preferred embodiments of the present invention, examples of which are illustrated in the accompanying drawings. Where possible, the same reference numerals will be used to illustrate like elements throughout the specification.

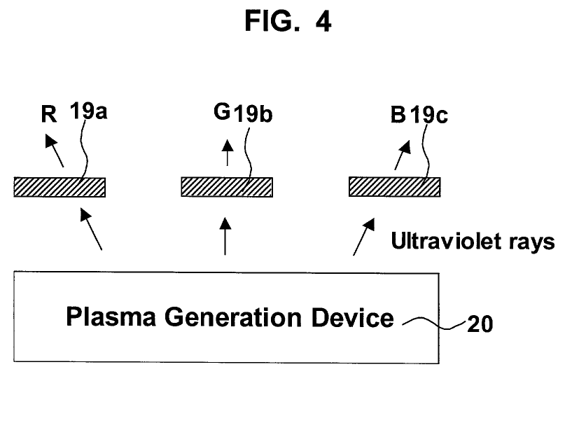

FIG. 4 illustrates a schematic diagram of a plasma switched organic photoluminescent display (hereinafter abbreviated PSOPLD) according to the present invention.

Referring to FIG. 4, when plasma is generated from a plasma generation device 20, ultraviolet (UV) rays are irradiated from the plasma. Organic photoluminescent layers 19a, 19b, and 19c are excited by the UV rays so as to irradiate visible rays consisting of red R, green G, and blue B. In this case, the plasma generation device plays a role as a switch determining whether the organic photoluminescent layers 19a, 19b, and 19c emit light.

[First Embodiment]

A plasma switched organic photoluminescent display (hereinafter abbreviated PSOPLD) and a fabricating method thereof according to a first embodiment of the present invention are described as follows.

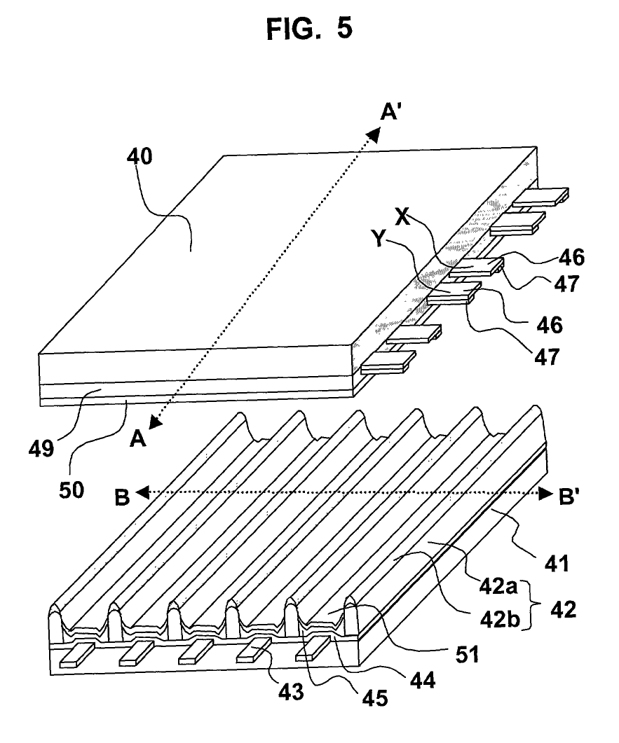

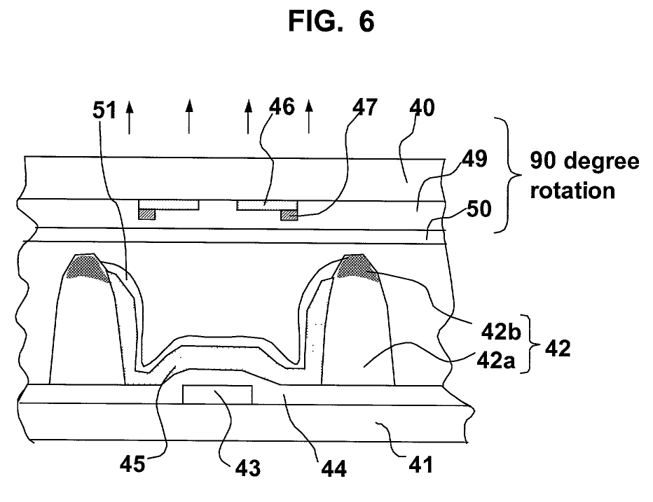

FIG. 5 illustrates a schematic bird's-eye view of PSOPLD according to a first embodiment of the present invention, and FIG. 6 illustrates schematically cross-sectional views of upper and lower plates of PSOPLD shown in FIG. 5 along bisecting lines A-A′ and B-B′, respectively.

Referring to FIG. 5 and FIG. 6, PSOPLD according to the first embodiment of the present invention includes an upper plate and a lower plate.

The lower plate includes a transparent rear substrate 41, address electrodes 43, a white back dielectric layer 44, barrier ribs 42, organic photoluminescent layers 45, and photoluminescent-layer protecting layers 51.

And, the upper plate includes a transparent front substrate 40, transparent sustain electrodes 46, auxiliary sustain electrodes (bus electrodes) 47, a transparent dielectric layer 49, and a protecting layer 50.

A plurality of the address electrodes 43 are formed on the transparent rear substrate 41 like stripes in parallel each other by one of vacuum evaporation, screen print, and photolithography.

The white back dielectric layer 44 is formed on the rear substrate 41 including the address electrodes 43 by one of vacuum evaporation, screen print, and photolithography.

A plurality of the barrier ribs 42 are formed in parallel each other on the exposed white back dielectric layer 44 between the address electrodes respectively by one of vacuum evaporation, screen print, sandblast, and photolithography. Specifically, upper parts of the barrier ribs 42 are formed to have a color of black so as to increase a contrast ratio of a panel. When the barrier ribs 42 are formed by screen print, lower barrier ribs 42a are formed using a general glass-based paste and upper barrier ribs 42b are formed using a black paste containing a general glass component mixed with Cr₂O₃, MnO₂ or the like.

A plurality of the organic photoluminescent layers 45 are arranged like stripes on the white back dielectric layer 44 between the barrier ribs 42 so as to be overlapped with the address electrodes 43, respectively. The organic photoluminescent layers 45 are formed by thermal vacuum evaporation using a low molecular material. Instead, the organic photoluminescent layers 45 are formed by one of spin coating, screen print, ink-jet, and the like using a high molecular material. In this case, the organic photoluminescent layers 45 are arranged in a manner that red, green, and blue luminescent layers constructing a unit or group are repeated thereon.

The photoluminescent-layer protecting layers 51 are formed on surfaces of the barrier ribs 42 and organic photoluminescent layers 45 by one of thermal vacuum evaporation, chemical vapor deposition, sputtering, and electron beam deposition using a material enabling to transmit ultraviolet rays irradiated from a plasma such as MgF₂, SiO₂, or CaF₂. Generally, MgF₂ is known as a material enabling to transmit a ultraviolet ray of which wavelength is over 147 nm.

Meanwhile, a plurality of the sustain electrodes 46 formed of a transparent material are arranged like stripes in parallel each other on the transparent front substrate 40 by forming and patterning ITO (indium tin oxide) using photolithography. In this case, every two X and Y of the adjacent sustain electrodes 46 construct one sustain electrode pair so as to provide a plurality of pairs of the sustain electrodes 46.

A plurality of auxiliary sustain electrodes 47 are formed right on the transparent sustain electrodes 46 respectively by one of screen print, photolithography, and the like so as to reduce each resistance of the sustain electrodes 46. In this case, a width of each of the auxiliary sustain electrodes 47 is formed to be shorter than that of each of the sustain electrodes 46.

The transparent dielectric layer 49 is formed on the front substrate 40 so as to cover the transparent sustain electrodes 46 and auxiliary sustain electrodes 47.

The protecting layer 50 is formed on the transparent dielectric layer 49 by one of vacuum evaporation, thermal vacuum evaporation, sputtering, chemical vapor deposition, e-beam deposition, and the like using a material having a sufficient secondary electron discharge coefficient such as MgO and the like in order to protect the transparent dielectric layer 49 from plasma etch as well as help to generate a plasma with ease.

Besides, as not shown in the drawing, after a hardened resin of UV epoxy base is drawn on a panel circumference of the upper plate by being released through a nozzle, the upper and lower plates are aligned each other. A sealing is carried out on the aligned upper and lower plates using a high pressure Hg lamp. A plasma discharge gas is injected into a plurality of discharge spaces.

Instead of drawing the hardened resin on the upper plate, the sealing may be carried out in a manner that the hardened resin is drawn on a circumferential part of the lower plate by being released through a nozzle.

When the upper and lower plates are aligned each other, the front substrate of the upper plate is arranged to confront the rear substrate of the lower plate so that the sustain electrodes cross the barrier ribs 42 at right angle as well as the photoluminescent-layer protecting layers 51 confront the protecting layer 50.

Meanwhile, as it is difficult to establish the barrier ribs 42 to have the same height exactly, a most outer wall (not shown in the drawing) taller than any other barrier ribs 42 is installed at a circumference of the lower plate. Then, a plurality of the discharge spaces between the barrier ribs 42 become completely sealed off from surroundings by combining to attach the most outer wall to the protecting layer 50 of the upper plate.

In order to increase a contrast ratio of the PSOPLD described in the first embodiment, another embodiment of the present invention requires a plurality of black stripes between the sustain electrodes, which is described in a second embodiment according to the present invention.

[Second Embodiment]

A plasma switched organic photoluminescent display (hereinafter abbreviated PSOPLD) and a fabricating method thereof according to a second embodiment of the present invention are described as follows.

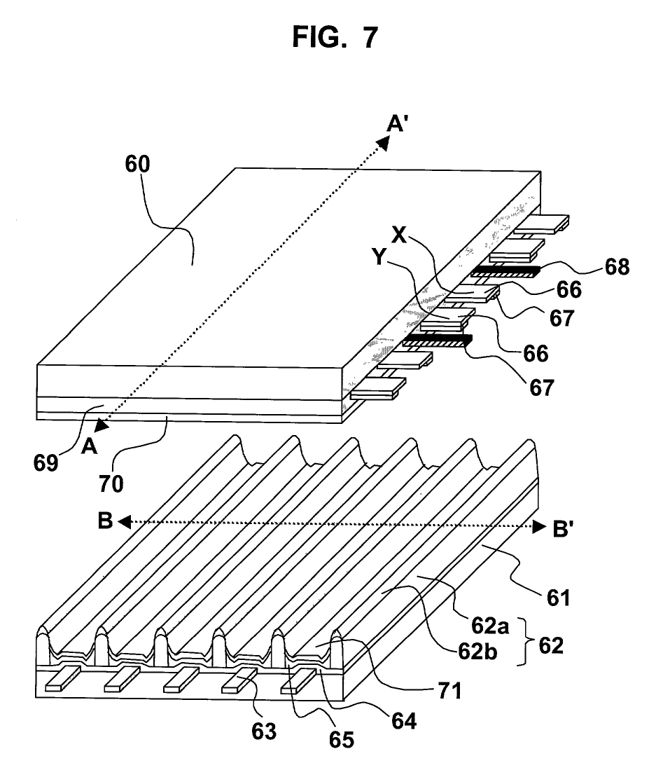

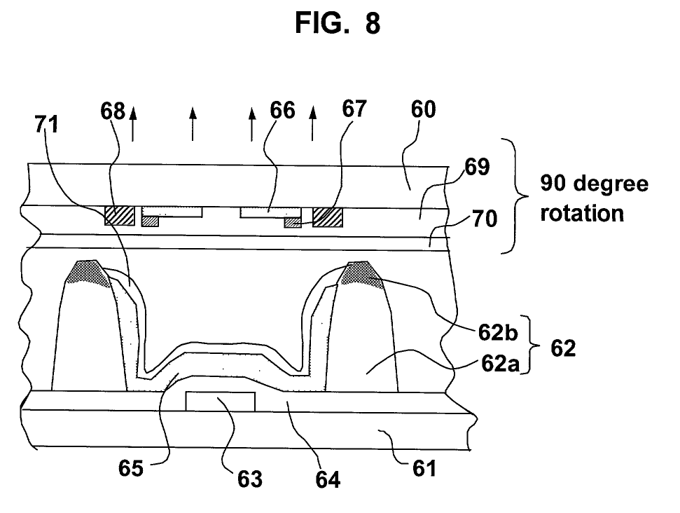

FIG. 7 illustrates a schematic bird'-eye view of PSOPLD according to a second embodiment of the present invention, and FIG. 8 illustrates schematically cross-sectional views of upper and lower plates of PSOPLD shown in FIG. 7 along bisecting lines A-A′ and B-B′, respectively.

Referring to FIG. 7 and FIG. 8, PSOPLD according to the second embodiment of the present invention includes an upper plate and a lower plate.

The lower plate includes a transparent rear substrate 61, address electrodes 63, a white back dielectric layer 64, barrier ribs 62, organic photoluminescent layers 65, and photoluminescent-layer protecting layers 71.

And, the upper plate includes a transparent front substrate 60, transparent sustain electrodes 66, auxiliary sustain electrodes (bus electrodes) 67, black stripes 68, a transparent dielectric layer 69, and a protecting layer 70.

A plurality of the address electrodes 63 are formed on the transparent rear substrate 61 in a predetermined direction like stripes in parallel each other by one of vacuum evaporation, screen print, and photolithography.

The white back dielectric layer 64 is formed on the rear substrate 61 including the address electrodes 63 by one of vacuum evaporation, screen print, and photolithography.

A plurality of the barrier ribs 62 are formed in parallel on the exposed white back dielectric layer 44 between the address electrodes 63 respectively by one of vacuum evaporation, screen print, sandblast, and photolithography so as not to be overlapped with the address electrodes 63. Specifically, upper parts of the barrier ribs 62 are formed to have a color of black so as to increase a contrast ratio of a panel. When the barrier ribs 62 are formed by screen print, lower barrier ribs 62a are formed using a general glass-based paste and upper barrier ribs 42b are formed using a black paste containing a general glass component mixed with Cr₂O₃, MnO₂ or the like.

A plurality of the organic photoluminescent layers 65 are arranged like stripes in parallel each other on the white back dielectric layer 64 between the barrier ribs 62 so as to be overlapped with the address electrodes 63, respectively. The organic photoluminescent layers 65 are formed by thermal vacuum evaporation using a low molecular material. Instead, the organic photoluminescent layers 65 may be formed by one of spin coating, screen print, ink-jet, and the like using a high molecular material. In this case, the organic photoluminescent layers 65 are preferably arranged in a manner that red, green, and blue luminescent layers constructing a unit or group are repeated thereon.

The photoluminescent-layer protecting layers 71 are formed on surfaces of the barrier ribs 42 in part and organic photoluminescent layers 65 by one of thermal vacuum evaporation, chemical vapor deposition, sputtering, and electron beam deposition using a material enabling to transmit ultraviolet rays irradiated from a plasma such as MgF₂, SiO₂, or CaF₂. Generally, MgF₂ is known as a material enabling to transmit an ultraviolet ray of which wavelength is over 147 nm.

Meanwhile, a plurality of the sustain electrodes 66 formed of a transparent material are arranged like stripes in parallel each other on the transparent front substrate 60 by forming and patterning ITO (indium tin oxide) using photolithography. In this case, every two X and Y of the adjacent sustain electrodes 66 construct one sustain electrode pair so as to provide a plurality of pairs of the sustain electrodes 66.

A plurality of auxiliary sustain electrodes 67 are formed right on the transparent sustain electrodes 66 respectively by one of screen print, photolithography, and the like so as to reduce each resistance of the sustain electrodes 66. In this case, a width of each of the auxiliary sustain electrodes 67 is formed to be shorter than that of each of the sustain electrodes 66.

Moreover, a plurality of the black stripes 68 are formed respectively between and in parallel with the sustain electrode pairs 66 on the front substrate 60 by one of vacuum evaporation, screen print, or photolithography so as to increase a contrast ratio of a panel.

And, the transparent dielectric layer 69 is formed on the front substrate 60 so as to cover the transparent sustain electrodes 66 and auxiliary sustain electrodes 67.

The protecting layer 70 is formed on the transparent dielectric layer 69 by one of vacuum evaporation, thermal vacuum evaporation, sputtering, chemical vapor deposition, e-beam deposition, and the like using a material having a sufficient secondary electron discharge coefficient such as MgO and the like in order to protect the transparent dielectric layer 49 from plasma etch as well as help to generate a plasma with ease.

Besides, as not shown in the drawing, after a hardened resin of UV epoxy base is drawn on a panel circumference of the upper plate by being released through a nozzle, the upper and lower plates are aligned each other. A sealing is carried out on the aligned upper and lower plates using a high pressure Hg lamp. A plasma discharge gas is injected into a plurality of discharge spaces.

Instead of drawing the hardened resin on the upper plate, the sealing may be carried out in a manner that the hardened resin is firstly drawn on a circumferential part of the lower plate by being released through a nozzle.

When the upper and lower plates are aligned each other, the front substrate 60 of the upper plate is arranged to confront the rear substrate 61 of the lower plate so that the sustain electrodes 66 cross the barrier ribs 62 at right angle as well as the photoluminescent-layer protecting layers 71 confront the protecting layer 70.

Meanwhile, as it is difficult to establish the barrier ribs 62 to have the same height exactly, a most outer wall (not shown in the drawing) taller than any other barrier ribs 62 is installed at a circumference of the lower plate. Then, a plurality of the discharge spaces between the barrier ribs 62 become completely sealed off from surroundings by combining to attach the most outer wall to the protecting layer 70 of the upper plate.

[Third Embodiment]

A plasma switched organic photoluminescent display (hereinafter abbreviated PSOPLD) and a fabricating method thereof according to a third embodiment of the present invention are described as follows.

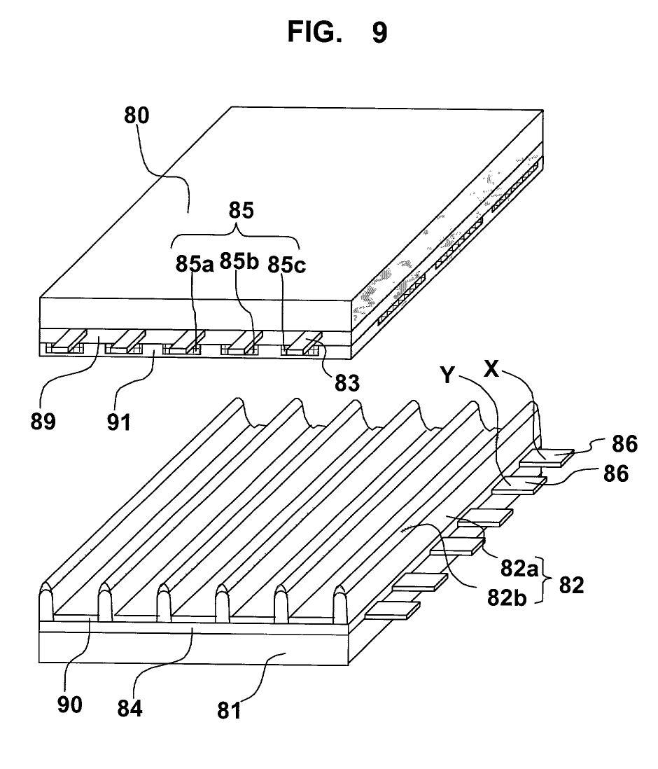

FIG. 9 illustrates a schematic bird's-eye view of PSOPLD according to a third embodiment of the present invention.

Referring to FIG. 9, PSOPLD according to the third embodiment of the present invention includes an upper plate and a lower plate.

The lower plate includes a transparent rear substrate 81, sustain electrodes 86, a white back dielectric layer 84, barrier ribs 82, and protecting layers 90.

And, the upper plate includes a transparent front substrate 80, address electrodes 83, a transparent dielectric layer 89, organic photoluminescent layers 85, and a photoluminescent-layer protecting layer 91.

A plurality of the sustain electrodes 86 formed of a transparent material are arranged like stripes in parallel each other on the transparent rear substrate 81 using one of vacuum evaporation, screen print, and photolithography. In this case, every two of the adjacent sustain electrodes X and Y construct one sustain electrode pair so as to provide a plurality of pairs of the sustain electrodes 86.

The white back dielectric layer 84 is formed on the rear substrate 81 including the sustain electrodes 86 by one of vacuum evaporation, screen print, and photolithography.

A plurality of the barrier ribs 82 are formed in parallel each other on the white back dielectric layer 84 by one of vacuum evaporation, screen print, sandblast, photolithography, and the like so as to cross the sustain electrodes 86. Specifically, upper parts of the barrier ribs 82 are formed to have a color of black so as to increase a contrast ratio of a panel. When the barrier ribs 82 are formed by screen print, lower barrier ribs 82a are formed using a general glass-based paste and upper barrier ribs 82b are formed using a black paste containing a general glass component mixed with Cr₂O₃, MnO₂ or the like.

The protecting layers 90 are formed on the white back dielectric layer 84 by one of vacuum evaporation, thermal vacuum evaporation, sputtering, chemical vapor deposition, e-beam deposition, and the like using a material having a sufficient secondary electron discharge coefficient such as MgO and the like in order to protect the white back dielectric layer 84 from plasma etch as well as help to generate a plasma with ease.

Meanwhile, a construction of the upper plate is described in the following.

A plurality of the address electrodes 83 are formed on the transparent front substrate 80 like stripes in parallel each other by one of vacuum evaporation, screen print, photolithography, and the like.

The transparent dielectric layer 89 is formed on the front substrate 80 including the address electrodes 83 by one of thermal vacuum evaporation, screen print, photolithography, and the like using a metal mask.

A plurality of the organic photoluminescent layers 85 are arranged on the transparent dielectric layer 89 like rectangles or dots each having a pixel size so as to be overlapped with the corresponding address electrodes 83. Specifically, the organic photoluminescent layers 85 are arranged so as to lie between the barrier ribs 82 when the upper and lower plates are aligned to each other. In this case, the organic photoluminescent layers 85 are formed by thermal vacuum evaporation using a low molecular material. Instead, the organic photoluminescent layers 85 are formed by one of spin coating, screen print, ink-jet, and the like using a high molecular material. Besides, the organic photoluminescent layers 85 are preferably arranged in a manner that red, green, and blue luminescent layers 85a, 85b, and 85c constructing a unit or group are repeated thereon.

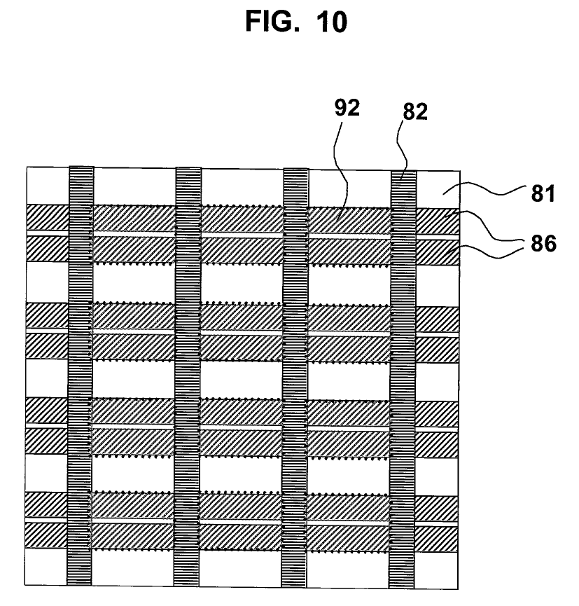

FIG. 10 illustrates a layout of the lower plate of the PSOPLD according to the third embodiment of the present invention in FIG. 9, in which a plurality of the sustain electrodes 86 and a plurality of the barrier ribs 82 are shown.

Referring to FIG. 10, each of pixel display parts 92, which are designated by dotted lines and realize various colors by a plasma drive, lies between a pair of the barrier ribs 82 as well as is overlapped with the corresponding sustain electrode pair constructed with the two adjacent sustain electrodes 86. Thus, each of the pixel display parts 92 is defined in such a manner.

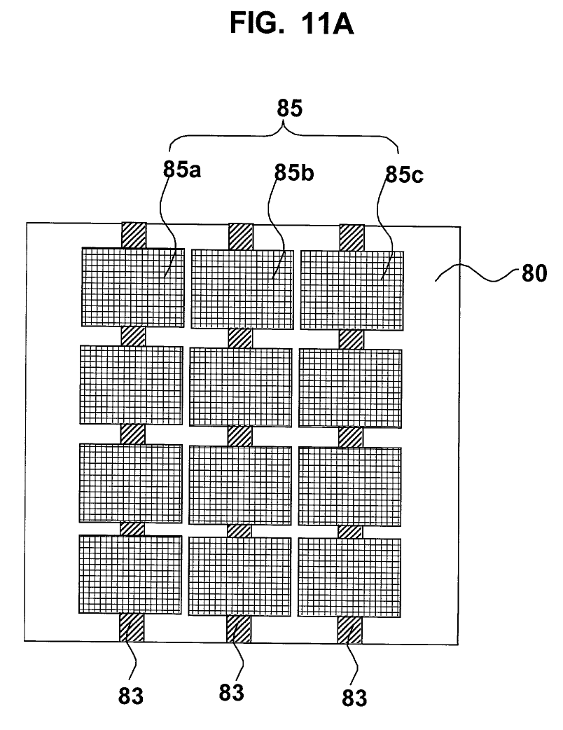

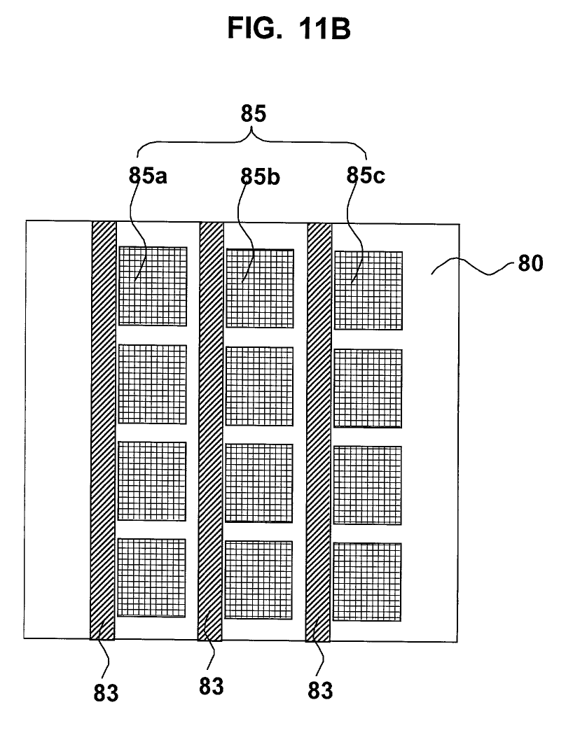

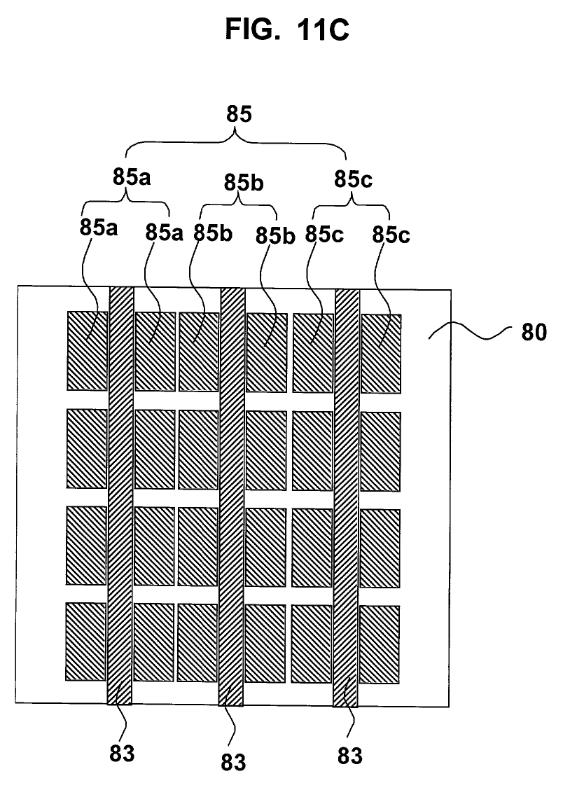

FIG. 11A to FIG. 11C illustrate layouts of the upper plates of PSOPLD according to the third embodiment of the present invention, in which a plurality of the address electrodes 83 and patterns of a plurality of the organic photoluminescent layers 85 (85a, 85b, 85c) are shown respectively.

Referring to FIG. 11A, each of the organic photoluminescent layers 85 is overlapped with the corresponding address electrode 83 so as to cover the whole pixel display part shown in FIG. 10. In this case, each of the address electrodes 83 lies under the middle part of the corresponding organic photoluminescent layer 85 having a figure of rectangle or dot.

Yet, such a layout may degrade the overlapped part between the corresponding address electrode 83 and the organic photoluminescent layer 85 due to a voltage applied to the driven address electrode 83, thereby reducing the durability of the device.

Such a disadvantage or problem is settled by the layout shown in FIG. 11B.

Referring to FIG. 11B, the address lines 83 are arranged at one edges of the corresponding pixel display parts 92 shown in FIG. 10, respectively. And, the organic photoluminescent layers 85 (85a, 85b, 85c) are formed to cover the rest parts of the pixel display parts 92 shown in FIG. 10 so as not to be overlapped with the address electrodes 83, respectively.

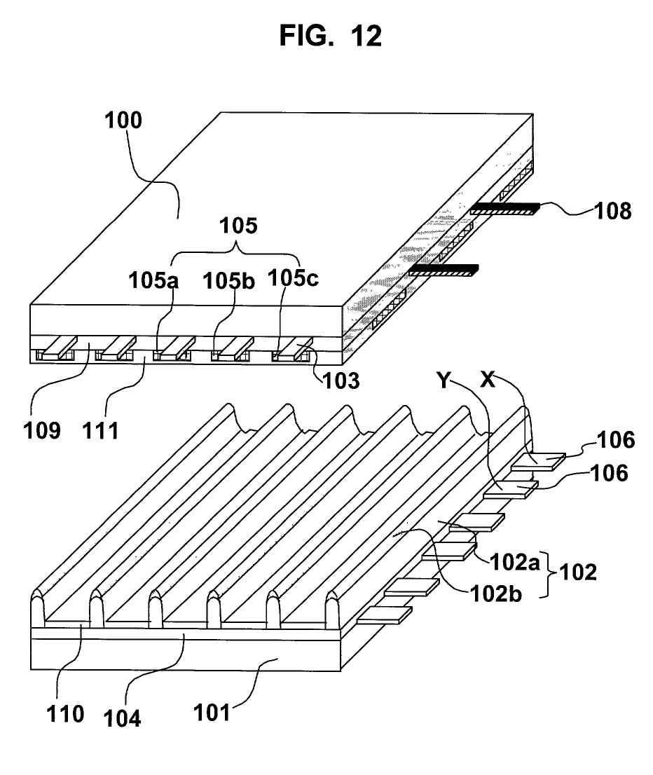

Instead, as shown in FIG. 11C, the address electrodes 83 are arranged so as to lie in the middle parts of the corresponding pixel display parts 92 shown in FIG. 12, respectively. And, the organic photoluminescent layers 85 (85a, 85b, 85c) are patterned like dots or rectangles divided into pairs of equal parts centering around the corresponding address electrodes 83 so as to cover the rest areas of the pixel display parts 92 which fail to be overlapped with the corresponding address electrodes 83, respectively.

Continued on the description of FIG. 9, the photoluminescent-layer protecting layer 91 is formed on the transparent dielectric layer 89 including the organic photoluminescent layers 85 by one of thermal vacuum evaporation, chemical vapor deposition, sputtering, and electron beam deposition using a material enabling to transmit ultraviolet rays irradiated from a plasma such as MgF₂, SiO₂, or CaF₂. Generally, MgF₂ is known as a material enabling to transmit an ultraviolet ray of which wavelength is over 147 nm.

Moreover, the protecting layers 90 in the rear substrate 81 are rarely formed on lateral sides of the barrier ribs 82. It is preferable that the protecting layers 90 cover at least the surface of the white back dielectric layer 84 free from the barrier ribs 82.

Besides, as not shown in the drawing, after a hardened resin of UV epoxy base is drawn on a panel circumference of the upper plate by being released through a nozzle, the upper and lower plates are aligned each other. A sealing is carried out on the aligned upper and lower plates using a high pressure Hg lamp. A plasma discharge gas is injected into a plurality of discharge spaces.

Instead of drawing the hardened resin on the upper plate, the sealing may be carried out in a manner that the hardened resin is drawn on a circumferential part of the lower plate by being released through a nozzle.

When the upper and lower plates are aligned each other, the front substrate 80 of the upper plate is arranged to confront the rear substrate 81 of the lower plate so that the address electrodes 83 are not overlapped with the barrier ribs 82 as well as the photoluminescent-layer protecting layer 91 of the upper plate confronts the protecting layers 90 of the lower plate.

Meanwhile, as it is difficult to establish the barrier ribs 82 to have the same height exactly, a most outer wall (not shown in the drawing) taller than any other barrier ribs 82 is installed at a circumference of the lower plate. Then, a plurality of the discharge spaces between the barrier ribs 82 become completely sealed off from surroundings by combining to attach the most outer wall to the photoluminescent-layer protecting layer 91 of the upper plate.

FIG. 12 illustrates a schematic bird's-eye view of PSOPLD according to a fourth embodiment of the present invention.

Referring to FIG. 12, PSOPLD according to the fourth embodiment of the present invention includes an upper plate and a lower plate.

The lower plate includes a transparent rear substrate 101, sustain electrodes 106, a white back dielectric layer 104, barrier ribs 102, and protecting layers 110.

And, the upper plate includes a transparent front substrate 100, address electrodes 103, black stripes 108, a transparent dielectric layer 109, organic photoluminescent layers 105, and a photoluminescent-layer protecting layer 111.

A plurality of the sustain electrodes 106 formed of a transparent material are arranged like stripes in parallel each other on the transparent rear substrate 101 using one of vacuum evaporation, screen print, and photolithography. In this case, every two of the adjacent sustain electrodes X and Y construct one sustain electrode pair so as to provide a plurality of pairs of the sustain electrodes 106.

The white back dielectric layer 104 is formed on the rear substrate 101 including the sustain electrodes 106 by one of vacuum evaporation, screen print, and photolithography.

A plurality of the barrier ribs 102 are formed in parallel each other on the white back dielectric layer 104 by one of vacuum evaporation, screen print, sandblast, photolithography, and the like so as to cross the sustain electrodes 106. Specifically, upper parts of the barrier ribs 102 are formed to have a color of black so as to increase a contrast ratio of a panel. When the barrier ribs 102 are formed by screen print, lower barrier ribs 102a are formed using a general glass-based paste and upper barrier ribs 102b are formed using a black paste containing a general glass component mixed with Cr₂O₃, MnO₂ or the like.

The protecting layers 110 are formed on the white back dielectric layer 104 by one of vacuum evaporation, thermal vacuum evaporation, sputtering, chemical vapor deposition, e-beam deposition, and the like using a material having a sufficient secondary electron discharge coefficient such as MgO and the like in order to protect the white back dielectric layer 104 from plasma etch as well as help to generate a plasma with ease.

Meanwhile, a construction of the upper plate is described in the following.

A plurality of the address electrodes 103 are formed on the transparent front substrate 100 like stripes in parallel each other by one of vacuum evaporation, screen print, photolithography, and the like.

A plurality of the black stripes 108 are formed on the front substrate 100 in parallel each other so as to cross the address electrodes 103 at right angle in order to increase a contrast ratio of a panel. In this case, the black stripes 108, when the upper and lower plates are aligned to each other, are patterned so as to confront parts between the sustain electrode pairs constructed with the two adjacent sustain electrodes X and Y on the rear substrate 101 using one of vacuum evaporation, screen print, photolithography, and the like.

The transparent dielectric layer 109 is formed on the front substrate 100 including the address electrodes 103 and black stripes 108 by one of thermal vacuum evaporation, screen print, photolithography, and the like using a metal mask.

A plurality of the organic photoluminescent layers 105 are arranged on the transparent dielectric layer 109 like rectangles or dots each having a pixel size so as to be overlapped with the corresponding address electrodes 103. Specifically, the organic photoluminescent layers 105 are arranged so as to confront parts between the barrier ribs 102 when the upper and lower plates are aligned to each other. In this case, the organic photoluminescent layers 105 are formed by thermal vacuum evaporation using a low molecular material. Instead, the organic photoluminescent layers 105 are formed by one of spin coating, screen print, ink-jet, and the like using a high molecular material. Besides, the organic photoluminescent layers 105 are preferably arranged in a manner that red, green, and blue luminescent layers 105a, 105b, and 105c constructing a unit or group are repeated thereon.

In the fourth embodiment of the present invention, the patterns of the organic photoluminescent layers 105 like rectangles or dots in connection with the address electrodes 103 are the same as shown in FIG. 11A to FIG. 11C.

Namely, first, each of the address electrodes 103 is located below a middle part of the corresponding pixel area, and each of the organic photoluminescent layers 105 like dots or rectangles lies over the corresponding whole pixel area. Second, in order to avoid the degradation due to the driven address electrodes 103, each of the address electrodes 103 is located at one edge of the corresponding pixel area and the organic photoluminescent layers 105 are formed to cover the rest of the pixel areas failing to be overlapped with the address electrodes 103, respectively. Third, each of the organic photoluminescent layers 105 like rectangles or dots is formed to cover the pixel area bisected equally along the corresponding address electrode 103 so that the organic photoluminescent layers 105 are not overlapped with the corresponding address electrodes 103.

Meanwhile, the photoluminescent-layer protecting layer 111 is formed on the transparent dielectric layer 109 including the organic photoluminescent layers 105 by one of thermal vacuum evaporation, chemical vapor deposition, sputtering, and electron beam deposition using a material enabling to transmit ultraviolet rays irradiated from a plasma such as MgF₂, SiO₂, or CaF₂. Generally, MgF₂ is known as a material enabling to transmit an ultraviolet ray of which wavelength is over 147 nm.

Moreover, the protecting layers 110 in the rear substrate 101 are rarely formed on lateral sides of the barrier ribs 102. It is sufficient that the protecting layers 110 cover at least the surface of the white back dielectric layer 104 free from the barrier ribs 102.

Besides, as not shown in the drawing, after a hardened resin of UV epoxy base is drawn on a panel circumference of the upper plate by being released through a nozzle, the upper and lower plates are aligned each other. A sealing is carried out on the aligned upper and lower plates using a high pressure Hg lamp. A plasma discharge gas is injected into a plurality of discharge spaces.

Instead of drawing the hardened resin on the upper plate, the sealing may be carried out in a manner that the hardened resin is drawn on a circumferential part of the lower plate by being released through a nozzle.

When the upper and lower plates are aligned each other, the front substrate 100 of the upper plate is arranged to confront the rear substrate 101 of the lower plate so that the address electrodes 103 are not overlapped with the barrier ribs 102 as well as the photoluminescent-layer protecting layer 111 of the upper plate confronts the protecting layers 110 of the lower plate.

Meanwhile, as it is difficult to establish the barrier ribs 102 to have the same height exactly, a most outer wall(not shown in the drawing) taller than any other barrier ribs 102 is installed at a circumference of the lower plate. Then, a plurality of the discharge spaces between the barrier ribs 102 become completely sealed off from surroundings by combining to attach the most outer wall to the photoluminescent-layer protecting layer 111 of the upper plate.

[Fifth Embodiment]

A plasma switched organic photoluminescent display (hereinafter abbreviated PSOPLD) and a fabricating method thereof according to a fifth embodiment of the present invention are described as follows.

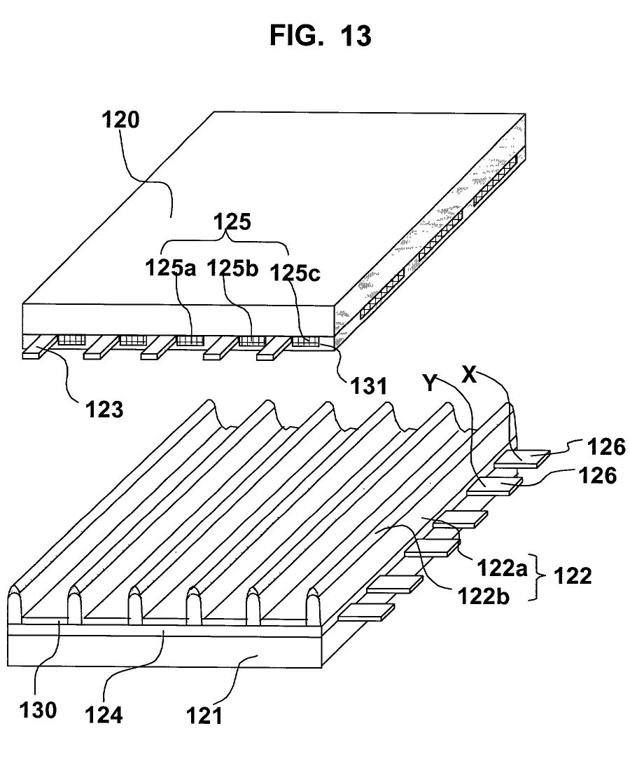

FIG. 13 illustrates a schematic bird's-eye view of PSOPLD according to a fifth embodiment of the present invention.

Referring to FIG. 13, PSOPLD according to the fifth embodiment of the present invention includes an upper plate and a lower plate.

The lower plate includes a transparent rear substrate 121, sustain electrodes 126, a white back dielectric layer 124, barrier ribs 122, and protecting layers 130.

And, the upper plate includes a transparent front substrate 120, address electrodes 123, organic photoluminescent layers 125, and a photoluminescent-layer protecting layer 131.

The lower plate is constructed as follows.

A plurality of the sustain electrodes 126 formed of a transparent material are arranged like stripes in parallel each other on the transparent rear substrate 121 using one of vacuum evaporation, screen print, and photolithography. In this case, every two of the adjacent sustain electrodes X and Y construct one sustain electrode pair so as to provide a plurality of pairs of the sustain electrodes 126.

The white back dielectric layer 124 is formed on the rear substrate 121 including the sustain electrodes 126 by one of vacuum evaporation, screen print, and photolithography.

A plurality of the barrier ribs 122 are formed in parallel each other on the white back dielectric layer 124 by one of vacuum evaporation, screen print, sandblast, photolithography, and the like so as to cross the sustain electrodes 126. Specifically, upper parts of the barrier ribs 122 are formed to have a color of black so as to increase a contrast ratio of a panel. When the barrier ribs 122 are formed by screen print, lower barrier ribs 122a are formed using a general glass-based paste and upper barrier ribs 122b are formed using a black paste containing a general glass component mixed with Cr₂O₃, MnO₂ or the like.

The protecting layers 130 are formed on the white back dielectric layer 124 by one of vacuum evaporation, thermal vacuum evaporation, sputtering, chemical vapor deposition, e-beam deposition, and the like using a material having a sufficient secondary electron discharge coefficient such as MgO and the like in order to protect the white back dielectric layer 124 from plasma etch as well as help to generate a plasma with ease.

Meanwhile, a construction of the upper plate is described in the following.

A plurality of the address electrodes 123 are formed on the transparent front substrate 120 like stripes in parallel each other by one of vacuum evaporation, screen print, photolithography, and the like. In this case, the address electrodes 123 are formed to correspond to one edges of the barrier ribs 122, respectively.

A plurality of the organic photoluminescent layers 125 are arranged on the front substrate 120 like rectangles or dots each having a pixel size so as not to be overlapped with the corresponding address electrodes 123. In this case, the organic photoluminescent layers 125 are arranged to confront parts between the barrier ribs 122 when the upper and lower plates are aligned to each other. In this case, the organic photoluminescent layers 125 are formed by thermal vacuum evaporation using a low molecular material. Instead, the organic photoluminescent layers 125 may be formed by one of spin coating, screen print, ink-jet, and the like using a high molecular material. Besides, the organic photoluminescent layers 125 are preferably arranged in a manner that red, green, and blue luminescent layers 125a, 125b, and 125c constructing a unit or group are repeated thereon.

The photoluminescent-layer protecting layer 121 is formed on the front substrate 120 including the organic photoluminescent layers 125 by one of thermal vacuum evaporation, chemical vapor deposition, sputtering, and electron beam deposition using a material enabling to transmit ultraviolet rays irradiated from a plasma such as MgF₂, SiO₂, or CaF₂. Generally, MgF₂ is known as a material enabling to transmit an ultraviolet ray of which wavelength is over 147 nm.

Moreover, the protecting layers 130 in the rear substrate 121 are rarely formed on lateral sides of the barrier ribs 122. It is preferable that the protecting layers 130 cover at least the surface of the white back dielectric layer 124 free from the barrier ribs 122.

Besides, as not shown in the drawing, after a hardened resin of UV epoxy base is drawn on a panel circumference of the upper plate by being released through a nozzle, the upper and lower plates are aligned each other. A sealing is carried out on the aligned upper and lower plates using a high pressure Hg lamp. A plasma discharge gas is injected into a plurality of discharge spaces.

Instead of drawing the hardened resin on the upper plate first, the sealing may be carried out in a manner that the hardened resin is drawn on a circumferential part of the lower plate by being released through a nozzle.

When the upper and lower plates are aligned each other, the front substrate 120 of the upper plate is arranged to confront the rear substrate 121 of the lower plate so that the address electrodes 123 are not overlapped with the barrier ribs 122 as well as the photoluminescent-layer protecting layer 131 of the upper plate confronts the protecting layers 130 of the lower plate.

Furthermore, as it is difficult to establish the barrier ribs 122 to have the same height exactly, a most outer wall (not shown in the drawing) taller than any other barrier ribs 122 is installed at a circumference of the lower plate. Then, a plurality of the discharge spaces between the barrier ribs 122 become completely sealed off from surroundings by combining to attach the most outer wall to the photoluminescent-layer protecting layer 131 of the upper plate.

[Sixth Embodiment]

A plasma switched organic photoluminescent display (hereinafter abbreviated PSOPLD) and a fabricating method thereof according to a sixth embodiment of the present invention are described as follows.

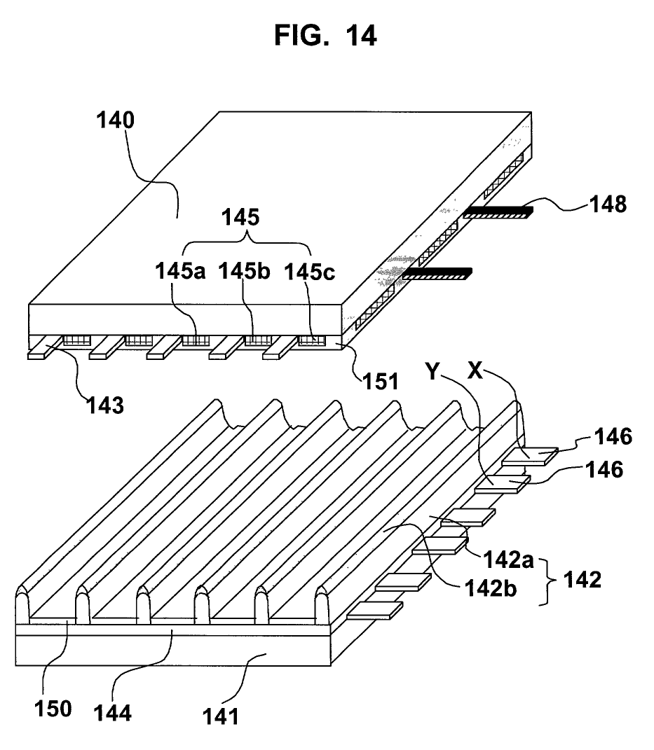

FIG. 14 illustrates a schematic bird's-eye view of PSOPLD according to a sixth embodiment of the present invention.

Referring to FIG. 14, PSOPLD according to the sixth embodiment of the present invention includes an upper plate and a lower plate.

The lower plate includes a transparent rear substrate 141, sustain electrodes 146, a white back dielectric layer 144, barrier ribs 142, and protecting layers 150.

And, the upper plate includes a transparent front substrate 140, address electrodes 143, black stripes 148, organic photoluminescent layers 145, and a photoluminescent-layer protecting layer 151.

The lower plate is constructed as follows.

A plurality of the sustain electrodes 146 formed of a transparent material are arranged like stripes in parallel each other on the transparent rear substrate 121 using one of vacuum evaporation, screen print, and photolithography. In this case, every two of the adjacent sustain electrodes X and Y construct one sustain electrode pair so as to provide a plurality of pairs of the sustain electrodes 146.

The white back dielectric layer 144 is formed on the rear substrate 141 including the sustain electrodes 146 by one of vacuum evaporation, screen print, and photolithography.

A plurality of the barrier ribs 142 are formed in parallel each other on the white back dielectric layer 144 by one of vacuum evaporation, screen print, sandblast, photolithography, and the like so as to cross the sustain electrodes 146. Specifically, upper parts of the barrier ribs 142 are formed to have a color of black so as to increase a contrast ratio of a panel. When the barrier ribs 142 are formed by screen print, lower barrier ribs 142a are formed using a general glass-based paste and upper barrier ribs 142b are formed using a black paste containing a general glass component mixed with Cr₂O₃, MnO₂ or the like.

The protecting layers 150 are formed on the white back dielectric layer 144 by one of vacuum evaporation, thermal vacuum evaporation, sputtering, chemical vapor deposition, e-beam deposition, and the like using a material having a sufficient secondary electron discharge coefficient such as MgO and the like in order to protect the white back dielectric layer 144 from plasma etch as well as help to generate a plasma with ease.

Meanwhile, a construction of the upper plate is described in the following.

A plurality of the address electrodes 143 are formed on the transparent front substrate 140 like stripes in parallel each other by one of vacuum evaporation, screen print, photolithography, and the like. In this case, the address electrodes 143 are formed to correspond to one edges of the barrier ribs 142, respectively.

A plurality of the black stripes 148 are formed on the front substrate 140 in parallel each other so as to cross the address electrodes 143 at right angle in order to increase a contrast ratio of a panel. In this case, the black stripes 148, when the upper and lower plates are aligned to each other, are patterned so as to confront parts between the sustain electrode pairs constructed with the two adjacent sustain electrodes X and Y on the rear substrate 141 using one of vacuum evaporation, screen print, photolithography, and the like.

A plurality of the organic photoluminescent layers 145 are arranged on the front substrate 140 like rectangles or dots each having a pixel size so as not to be overlapped with the corresponding address electrodes 143 and black stripes 148. In this case, the organic photoluminescent layers 145 are arranged to confront parts between the barrier ribs 142 when the upper and lower plates are aligned to each other. In this case, the organic photoluminescent layers 145 are formed by thermal vacuum evaporation using a low molecular material. Instead, the organic photoluminescent layers 145 may be formed by one of spin coating, screen print, ink-jet, and the like using a high molecular material. Besides, the organic photoluminescent layers 145 are preferably arranged in a manner that red, green, and blue luminescent layers 145a, 145b, and 145c constructing a unit or group are repeated thereon.

The photoluminescent-layer protecting layer 151 is formed on the front substrate 140 including the organic photoluminescent layers 145 by one of thermal vacuum evaporation, chemical vapor deposition, sputtering, and electron beam deposition using a material enabling to transmit ultraviolet rays irradiated from a plasma such as MgF₂, SiO₂, or CaF₂. Generally, MgF₂ is known as a material enabling to transmit an ultraviolet ray of which wavelength is over 147 nm.

Moreover, the protecting layers 150 in the rear substrate 141 are rarely formed on lateral sides of the barrier ribs 142. It is preferable that the protecting layers 150 cover at least the surface of the white back dielectric layer 144 free from the barrier ribs 142.

Besides, as not shown in the drawing, after a hardened resin of UV epoxy base is drawn on a panel circumference of the upper plate by being released through a nozzle, the upper and lower plates are aligned each other. A sealing is carried out on the aligned upper and lower plates using a high pressure Hg lamp. A plasma discharge gas is injected into a plurality of discharge spaces.

Instead of drawing the hardened resin on the upper plate first, the sealing may be carried out in a manner that the hardened resin is drawn on a circumferential part of the lower plate by being released through a nozzle.

When the upper and lower plates are aligned each other, the front substrate 140 of the upper plate is arranged to confront the rear substrate 141 of the lower plate so that the address electrodes 143 are not overlapped with the barrier ribs 142 as well as the photoluminescent-layer protecting layer 151 of the upper plate confronts the protecting layers 150 of the lower plate.

Furthermore, as it is difficult to establish the barrier ribs 142 to have the same height exactly, a most outer wall (not shown in the drawing) taller than any other barrier ribs 142 is installed at a circumference of the lower plate. Then, a plurality of the discharge spaces between the barrier ribs 142 become completely sealed off from surroundings by combining to attach the most outer wall to the photoluminescent-layer protecting layer 151 of the upper plate.

As mentioned in the above description, the photoluminescent material of the plasma switched organic photoluminescent display according to the present invention emits light not by a current but by ultraviolet rays irradiated from plasma.

Accordingly, the present invention using UV-rays as a light-emitting source needs no auxiliary layers such as hole injection, hole transport, electron transport layers, and the like to increase a luminescent efficiency.

And, the present invention is free from the degradation due to a current drive, thereby enabling to a durability of a panel.

Moreover, the present invention forms the photoluminescent layers with an organic luminescent material, thereby enabling to improve a yield for manufacturing PDP commercially.

Furthermore, the present invention takes advantage of a high efficiency of an organic luminescent material, thereby enabling to reduce a cost of production greatly.

The foregoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A plasma switched photoluminescent display comprising:
a plasma generating means for generating a plasma; and
an organic photoluminescent layer irradiating visible rays by being excited by UV rays generated from the plasma generating means, the organic photoluminescent layer formed of an organic photoluminescent material.

2. The plasma switched photoluminescent display of claim 1, wherein the organic photoluminescent layer includes a red luminescent layer, a green luminescent layer, and a blue luminescent layer.

3. A plasma switched organic photoluminescent display comprising:
a lower plate comprising:
a transparent rear substrate;
a plurality of address electrodes arranged in a first direction on the transparent rear substrate like stripes in parallel each other;
a white back dielectric layer on the transparent rear substrate including the address electrodes;
a plurality of barrier ribs arranged in parallel each other on the white back dielectric layer between the address electrodes in the first direction, respectively;
a plurality of organic photoluminescent layers on the exposed white back dielectric layer between the barrier ribs, respectively; and
a plurality of photoluminescent-layer-protecting layers on the organic photoluminescent layers, respectively; and
an upper plate comprising:
a transparent front substrate;
a plurality of transparent sustain electrodes arranged in parallel each other like stripes on the transparent front substrate in a second direction;
a plurality of auxiliary sustain electrodes on the sustain electrodes, respectively, so as to reduce resistances of the sustain electrodes;
a transparent dielectric layer on the front substrate so as to cover the sustain and auxiliary sustain electrodes; and
a protecting layer on the transparent dielectric layer, and
wherein the upper and lower plates are aligned to each other so that the address electrodes cross sustain electrode pairs at right angle, wherein each of the sustain electrode pairs is constructed with a pair of the sustain electrodes adjacent to each other, and wherein plasmas are generated from spaces between the barrier ribs, respectively.

4. The plasma switched organic photoluminescent display of claim 3, wherein the protecting layer is formed of MgO.

5. The plasma switched organic photoluminescent display of claim 3, wherein the photoluminescent-layer-protecting layers are formed one of MgF₂, SiO₂, and CaF₂.

6. The plasma switched organic photoluminescent display of claim 3, further comprising a plurality of black stripes between the sustain electrode pairs in the second direction, respectively.

7. The plasma switched organic photoluminescent display of claim 6, wherein the black stripes are formed on the front substrate.

8. The plasma switched organic photoluminescent display of claim 3, wherein the organic photoluminescent layers include red, green, and blue luminescent layers.

9. A plasma switched organic photoluminescent display comprising:
a lower plate comprising:
a transparent rear substrate;
a plurality of sustain electrodes arranged in parallel each other like stripes on the rear substrate in a first direction wherein every two of the adjacent sustain electrodes construct a sustain electrode pair; a white back dielectric layer on the rear substrate including the sustain electrodes;
a plurality of barrier ribs arranged in parallel each other on the white back dielectric layer in a second direction perpendicular to the first direction so as to cross the sustain electrodes at right angle, respectively; and
a plurality of protecting layers covering the white back dielectric layer exposed between the barrier ribs, respectively; and
an upper plate comprising:
a transparent front substrate;
a plurality of address electrodes arranged in a predetermined direction on the front substrate like stripes in parallel each other;
a transparent dielectric layer formed on the front substrate so as to cover the address electrodes;
a plurality of organic photoluminescent layers arranged on predetermined portions of the transparent dielectric layer so as to be overlapped with a plurality of pixel areas, wherein the pixel areas are defined by spaces between the barrier ribs overlapped with the sustain electrode pairs respectively when the upper and lower plates are aligned, and wherein each of the organic photoluminescent layers has a predetermined shape so as to cover the corresponding pixel area at least in part; and
a photoluminescent-layer-protecting layer on the transparent dielectric layer so as to cover the organic photoluminescent layers, and
wherein the upper and lower plates are aligned to each other in a manner that each of the address electrodes is placed between the barrier ribs and that each of the organic photoluminescent layers confronts the corresponding sustain electrode pair and wherein a plasma is generated form each space provided between the barrier ribs.

10. The plasma switched organic photoluminescent display of claim 9, wherein the photoluminescent-layer-protecting layer is formed one of MgF₂, SiO₂, and CaF₂.

11. The plasma switched organic photoluminescent display of claim 9, wherein the protecting layers are formed of MgO.

12. The plasma switched organic photoluminescent display of claim 9, the upper plate further comprising a plurality of black stripes over the front substrate so as to be overlapped with the spaces between the sustain electrode pairs, respectively.

13. The plasma switched organic photoluminescent display of claim 12, wherein the black stripes are covered with the transparent dielectric layer.

14. The plasma switched organic photoluminescent display of claim 9, wherein the organic photoluminescent layers centering around the corresponding address electrodes are symmetrically overlapped with the address electrodes, respectively.

15. The plasma switched organic photoluminescent display of claim 9, wherein each of the address electrodes is placed over one side of the corresponding barrier rib when the upper and lower plates are aligned to each other and wherein the organic photoluminescent layers are formed in the pixel areas respectively so as not to be overlapped with the address electrodes.

16. The plasma switched organic photoluminescent display of claim 9, wherein each of the address electrodes is placed over a middle part between the barrier ribs when the upper and lower plates are aligned to each other and wherein each of the organic photoluminescent layers is divided into a pair of equal parts in the pixel areas respectively so as not to be overlapped with the corresponding address electrode.

17. The plasma switched organic photoluminescent display of claim 9, wherein the organic photoluminescent layers include red, green, and blue luminescent layers.

18. A plasma switched organic photoluminescent display comprising:
a lower plate comprising:
a transparent rear substrate;
a plurality of sustain electrodes arranged in parallel each other like stripes on the rear substrate in a first direction wherein every two of the adjacent sustain electrodes construct a sustain electrode pair;
a white back dielectric layer on the rear substrate including the sustain electrodes;
a plurality of barrier ribs arranged in parallel each other on the white back dielectric layer in a second direction perpendicular to the first direction so as to cross the sustain electrodes at right angle, respectively; and
a plurality of protecting layers covering the white back dielectric layer exposed between the barrier ribs, respectively; and
an upper plate comprising:
a transparent front substrate;
a plurality of address electrodes arranged in a predetermined direction on the front substrate like stripes in parallel each other;
a plurality of organic photoluminescent layers arranged on predetermined portions of the transparent dielectric layer so as to be overlapped with a plurality of pixel areas, wherein the pixel areas are defined by spaces between the barrier ribs overlapped with the sustain electrode pairs respectively when the upper and lower plates are aligned, and wherein each of the organic photoluminescent layers adjacent to the corresponding address electrodes has a predetermined shape so as to cover the corresponding pixel area at least in part; and
a photoluminescent-layer-protecting layer on the front substrate so as to cover the address electrodes and organic photoluminescent layers, and
wherein the upper and lower plates are aligned to each other in a manner that each of the address electrodes is placed between the barrier ribs and that each of the organic photoluminescent layers confronts the corresponding sustain electrode pair and wherein a plasma is generated form each space provided between the barrier ribs.

19. The plasma switched organic photoluminescent display of claim 18, wherein the photoluminescent-layer-protecting layer is formed one of MgF₂, SiO₂, and CaF₂.

20. The plasma switched organic photoluminescent display of claim 18, wherein the protecting layers are formed of MgO.

21. The plasma switched organic photoluminescent display of claim 18, the upper plate further comprising a plurality of black stripes over the front substrate so as to be overlapped with the spaces between the sustain electrode pairs, respectively.

22. The plasma switched organic photoluminescent display of claim 18, wherein the organic photoluminescent layers include red, green, and blue luminescent layers.
